(19) United States
(12) Patent Application Publication
(10) Pub. No.: US 2014/0376089 A1
(43) Pub. Date: Dec. 25, 2014

(54) window-equipped cover for an optical device and manufacturing method for manufacturing a window-equipped cover for an optical device

(71) Applicant: Dietmar Haberer, Reutlingen (DE)

(72) Inventor: Dietmar Haberer, Reutlingen (DE)

(73) Assignee: Robert Bosch GmbH, Stuttgart (DE)

(21) Appl. No.: 14/311,827

(22) Filed: Jun. 23, 2014

(30) Foreign Application Priority Data
Jun. 24, 2013 (DE) 10 2013 211 886.4

(51) Int. Cl. G02B 27/00

(52) U.S. Cl. CPC G02B 27/0006
USPC 359/511; 29/428

(57) ABSTRACT

A manufacturing method for manufacturing a window-equipped cover for an optical device includes: forming an opening in a front side of a substrate, which opening has a first base partial surface at a first depth and a second base partial surface at a greater second depth; introducing a window plate into the opening in such a way that the window plate is supported on a first partial area of the first base partial surface and on a second partial area of the second base partial surface of the opening; and at least partially filling and/or covering a gap between at least one outer edge of the window plate and the opening, with the aid of at least one sealant and/or adhesive, from a side of the window plate oriented toward the front side of the substrate.

### BACKGROUND OF THE INVENTION

1. Field of the Invention

The present invention relates to a window-equipped cover for an optical device and to a manufacturing method for manufacturing a window-equipped cover for an optical device.

2. Description of the Related Art

A cover device for a micro-optomechanical component and manufacturing methods for such a cover device are described in published German patent application document DE 10 2010 062 118 A1. The particular cover device includes a substrate having a through opening, which has a constriction. A window seat for an (optical) window is formed with the aid of the constriction of the through opening, having fastening surfaces which are oriented inclined in relation to a maximum surface of the substrate. The fastening surfaces of the window seat are therefore aligned non-parallel and non-perpendicularly to the maximum surface of the substrate. In addition, a joining means is introduced directly between a window surface of the window, which is oriented toward the constriction, and the fastening surfaces of the window seat. The joining means may be deposited onto the window before an introduction of the window into the through opening. The joining means may optionally also be deposited on the fastening surfaces of the window seat before the insertion of the window into the through opening.

### BRIEF SUMMARY OF THE INVENTION

Due to the fastening of the at least one window plate in the at least one opening with the aid of at least one sealant and/or adhesive, which at least partially fills and/or covers the at least one gap between the at least one outer edge of the at least one window plate and the particular opening from the side of the at least one window plate oriented toward the first surface/front side of the substrate, a more secure seat of the at least one window plate may also be ensured if it is oriented at a strong inclination in relation to the first base partial surface and/or to the second base partial surface. It is therefore not necessary to adapt an orientation of the first base partial surface and the second base partial surface to a desired angle of inclination of the window plate introduced into the particular opening. This makes the structuring of the first base partial surface and the second base partial surface substantially easier. The present invention therefore makes it easier to manufacture a window-equipped cover. In addition, window-equipped covers may be manufactured more cost-effectively with the aid of the present invention.

It is to be noted once again that the present invention does not require an implementation of base partial surfaces in a substrate having an orientation oriented inclined in relation to a maximal external surface of the substrate. Instead, a reliable hold of the particular window plate in the associated opening is also ensured in the event of a significant inclination of the first base partial surface and/or the second base partial surface in relation to the particular window plate by the at least one partial filling/partial covering of the at least one gap between the at least one outer edge of the at least one window plate and the particular opening of the side of the at least one window plate oriented toward the first surface/front side of the substrate with the aid of the at least one sealant and/or adhesive.

In one advantageous specific embodiment of the window-equipped cover, the first base partial surface of the at least one opening at the first depth and/or the second base partial surface of the at least one opening at the second depth are implemented in parallel to the first surface of the substrate. Such base partial surfaces oriented in parallel to the first surface of the substrate are implementable with the aid of simple structuring processes. Therefore, in particular standard methods from the semiconductor technology may be used for manufacturing the window-equipped cover. Even in the case of a comparatively small design of the window-equipped cover, it may thus also still be manufactured with high quality in mass production.

In one further advantageous specific embodiment, a seal made of the at least one sealant and/or adhesive covers the at least one entire outer edge of the at least one window plate and frames a window middle surface of the particular window plate oriented toward the first surface of the substrate. A seal implemented in this way ensures a reliable hold of the contacted window plate in the associated opening. In addition, penetration of dust or dirt particles into the optical device having the window-equipped cover through the at least one gap between the at least one outer edge of the at least one window plate and the particular opening may be reliably prevented with the aid of such a seal.

The at least one gap between the at least one outer edge of the at least one window plate and the at least one opening is preferably filled and/or covered in a liquid-tight and/or airtight manner with the aid of the at least one seal. A liquid-tight cover/filling with the aid of the at least one seal ensures reliable protection of the optical device capped using the window-equipped cover from undesirable penetration of liquids. A desired partial vacuum or overpressure in the optical device equipped with the window-equipped cover may be set with the aid of an airtight seal. For example, an adjustability of at least one adjustable component of the optical device may be improved with the aid of a partial vacuum provided in such an optical device.

The advantages described in the above paragraphs are also ensured in an optical device having a corresponding window-equipped cover. The optical device may be/include, for example, a component or a mechanical component, in particular a micromechanical component. In particular, the optical device may be designed as a mirror device, for example, as a micro-mirror device. However, it is to be noted that the implementability of the optical device equipped with the window-equipped cover is not limited to the examples listed here.

The above-mentioned advantages are also implementable by carrying out a corresponding manufacturing method for manufacturing a window-equipped cover for an optical device.

Advantageously, the first base partial surface of the at least one opening at the first depth and/or the second base partial surface of the at least one opening at the second depth is/are preferably implemented in parallel to the front side of the substrate during the production of the at least one opening. Even in the case of a comparatively small extension of the at least one opening (in parallel to the front side of the substrate), the first base partial surface and/or the second base partial surface may therefore be manufactured with the aid of standard processes for structuring a substrate.

In addition, the at least one entire outer edge of the at least one window plate may be covered by the at least one sealant and/or adhesive in such a way that at least one seal is formed, which frames a window middle surface of the particular window plate oriented toward the front side of the substrate. The at least one gap between the at least one window plate and the at least one opening may therefore be filled and/or covered reliably in a liquid-tight and/or airtight manner with the aid of the at least one seal.

During the production of the at least one opening, the at least one first base partial surface is preferably implemented as a surface of a step, and the at least one window plate is supported on an edge of the step as the at least one partial area of the first base partial surface. The structuring of the at least one opening having the at least one step is possible with the aid of a variety of etching methods which are easily carried out.

In one advantageous specific embodiment, the at least one opening is implemented partially through the substrate before the introduction of the at least one window plate. Therefore, during later operation of the optical device having the finished manufactured window-equipped cover, a light beam may be irradiated without problems into the optical device or emitted out of the optical device.

As an alternative to the above-described procedure, after the introduction of the at least one window plate, at least one base area of the at least one opening, which is located between the first partial area of the first base partial surface and the second partial area of the second base partial surface, may be removed with the aid of etching starting from a rear side of the substrate. Such rear side etching may be easily carried out.

The manufacturing method may be carried out at the wafer level. Due to the usability of standard method steps, in particular from the semiconductor technology, even comparatively small window-equipped covers may be manufactured having a high quality and a relatively low error frequency in mass production by carrying out the manufacturing method at the wafer level.

The above-described advantages are also implementable by carrying out the corresponding manufacturing method for optical devices.

### BRIEF DESCRIPTION OF THE DRAWINGS

FIGS. 1a through 1c show schematic cross sections to explain one specific embodiment of the manufacturing method for manufacturing a window-equipped cover for an optical device.

FIG. 2 shows a schematic view of one specific embodiment of the window-equipped cover.

### DETAILED DESCRIPTION OF THE INVENTION

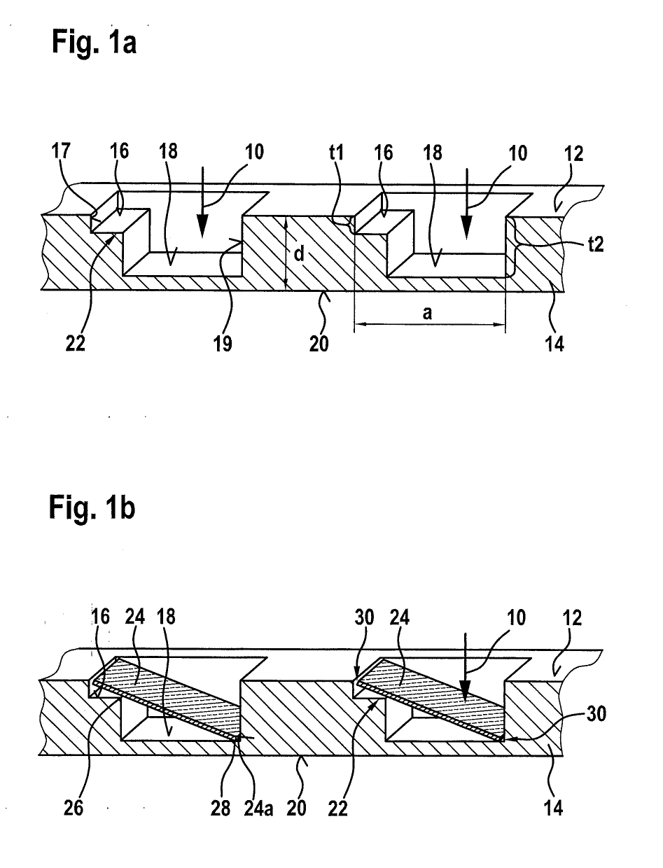

FIGS. 1a through 1c show schematic cross sections to explain one specific embodiment of the manufacturing method for manufacturing a window-equipped cover for an optical device.

The manufacturing method for manufacturing a window-equipped cover for an optical device may be carried out on the wafer level. Therefore, a plurality of window-equipped covers for optical devices may be manufactured simultaneously in mass production from a single wafer. However, it is to be noted that the following explanation of the manufacturing method at the wafer level is only to be interpreted as an example. Only one single window-equipped cover may also be manufactured by carrying out the manufacturing method.

In one method step of the manufacturing method, at least one opening 10 is structured into a front side 12 of a substrate 14. For example, an etching step may be carried out to structure the at least one opening 10. The etching of the at least one opening 10 is preferably carried out as a DRIE etching step and/or as a KOH etching step. Therefore, known and established methods may be used for structuring the at least one opening 10 in substrate 14. Known photolithography methods may also be used to establish a desired shape of the at least one opening 10.

The at least one opening 10 is formed having in each case at least one first base partial surface 16 of the at least one opening 10 at a first depth t1 to front side 12 of substrate 14 and one second base partial surface 18 of the at least one opening 10 at a greater second depth t2 to front side 12 of substrate 14. The advantages of base partial surfaces 16 and 18 at different depths t1 and t2 to front side 12 of substrate 14 will be described hereafter. Base partial surfaces 16 and 18 preferably lie on opposing outer edge areas of the at least one opening 10. For example, first base partial surface 16 lies on/adjacent to a first outer wall 17 of particular opening 10, while second base partial surface 18 lies on/adjacent to a second outer wall 19 of particular opening 10, which is oriented away from first outer wall 17. However, first base partial surface 16 may also be an inner area of first outer wall 17 of particular opening 10. First base partial surface 16 may therefore also be oriented perpendicularly to front side 12.

Preferably, during the production of the at least one opening 10, first base partial surface 16 of the at least one opening 10 at first depth t1 and/or second base partial surface 18 of the at least one opening 10 at second depth t2 are implemented in parallel to front side 12 of substrate 14 and/or a rear side 20 of substrate 14. It is to be expressly noted that when the manufacturing method is carried out, a conventional necessity for producing an opening according to the related art having surfaces which are oriented at an angle of inclination between 5° and 85° to front side 12/rear side 20 of substrate 14 is omitted. This makes it substantially easier to structure the at least one opening 10 in substrate 14.

One of the two processing sides 12 and 20 of substrate 14 may be understood as front side 12 of substrate 14. It is to be noted that the method may be carried out regardless of whether the later finished manufactured window-equipped cover is situated/fastened on at least one subunit of an optical device at front side 12 or at rear side 20, which is oriented opposite to front side 12, of substrate 14.

Substrate 14, which is used for carrying out the manufacturing method described here, may include at least one semiconductor material, for example, silicon. In particular, substrate 14 may be made completely from at least one semiconductor material, in particular from silicon. Instead of a substrate 14 made of a semiconductor material or a semiconductor wafer, however, a substrate 14 made of at least one other material, for example, a metal and/or a plastic, may also be used.

In one advantageous specific embodiment of the manufacturing method, during the production of the at least one opening 10, the at least one first base partial surface 16 is implemented as a surface of a step 22. The stepped implementation of the at least one opening 10 shown in FIG. 1a is only to be interpreted as an example, however.

Openings 10 shown in FIG. 1a have a maximum depth/second depth t2, which is less than a layer thickness d of substrate 14. As an alternative to such an implementation, the at least one opening 10 may also be implemented partially through substrate 14 already before a later introduction of at least one window plate. In particular, a base area of the at least one opening 14 [sic; 10] between first base partial surface 16 and second base partial surface 18 may be removed with the aid of an etching step carried out from front side 12 or from rear side 20 for this purpose.

The at least one opening 10 may have a maximum width a between 1 mm and 4 mm oriented in parallel to front side 12 of substrate 14. A maximum depth/second depth t2 of the at least one opening 10 may be between 100 μm and 1000 μm. The at least one opening 10 is implementable in particular as a stepped (two-step) cavity. The numeric values mentioned here are only to be interpreted as examples, however. The shape of the at least one opening 10 is also selectable relatively freely.

After the production of the at least one opening 10, at least one window plate 24 is introduced into the at least one opening 10. The introduction of the at least one window plate 24 is carried out in such a way that the at least one window plate 24 is supported on at least one first partial area 26 of first base partial surface 16 and on at least one second partial area 28 of second base partial surface 18 of particular opening 10. In particular, the at least one window plate 24 may be supported on an edge 26 of step 22 as first partial area 26 of first base partial surface 16.

The introduction of the at least one window plate 24 into the at least one opening 10 may take place, for example, by a pick-and-place method, in particular while using a die attacher. The manufacturing method described here is not restricted to a specific technology for introducing the at least one window plate 24 into the at least one opening 10, however. For example, the at least one window plate 24 may be structured/sawn out of a wafer made of a light-transmissive material, for example. For this purpose, the wafer may also be cut through/sawn through on the at least one outer edge 24a of the at least one window plate 24.

The at least one opening 10 has, due to different depths t1 and t2 of base partial surfaces 16 and 18, support surfaces of different depths for window plate 24 introduced therein, which preferably lie on opposing outer edge areas/outer walls 17 and 19 oriented away from one another of the at least one opening 10. A tilt/an angle of inclination toward front side 12 and/or rear side 20 of substrate 14 of glass plate 24 supported on base partial surfaces 16 and 18 may be established very precisely with the aid of a difference between depths t1 and t2. Since depths t1 and t2 may be brought very reliably to desired values with the aid of a variety of standard structuring methods, the (preferred) angle of inclination of the at least one window plate 24 in relation to front side 12 and/or rear side 20 of substrate 14 may also be maintained very precisely. For example, the at least one window plate 24 may be oriented at an angle of inclination between 5°-20° in relation to front side 12 and/or rear side 20 of substrate 14.

In particular, window plate 24 introduced into particular opening 10 may be supported deviating from an orientation of base partial surfaces 16 and 18. In particular, adjacent window plate 24 may be oriented inclined in relation to base partial surfaces 16 and 18. The at least one window plate 24 is supported on associated base partial surfaces 16 and 18, for example, in such a way that the particular window plate only touches second base partial surface 18 at one edge and a contact between window plate 24 and first base partial surface 16 only exists at one border area, one tip, or one edge of first base partial surface 16. The at least one window plate 24 is therefore supported in an inclined orientation to base partial surfaces 16 and 18.

The inclined arrangement shown in FIG. 1b of the at least one window plate 24 in the at least one opening 10 is linked to the advantage that the at least one window plate 24 may be concealed completely below/behind front side 12. By way of the inclined/tilted arrangement of the at least one window plate 24 achievable in this way within the at least one opening 10, the at least one window plate 24 is protected from damage, for example, scratching, and/or an accumulation of particles. In this way, the at least one window plate 24 may be reliably prevented from already being damaged or soiled during a following method step, a sale, a transport, or a use of the window-equipped cover/the optical device equipped therewith.

Due to the inclined orientation of the at least one window plate 24 in relation to front side 12/rear side 20 of substrate 14, the finished manufactured window-equipped cover may also be fastened in a simple way on at least one subunit of an optical device having an optical element, for example, a mirror or a filter, so that the at least one window plate 24 is oriented inclined to the nonadjustable optical element or the adjustable optical element which is provided in its rest position. Reflections of a light beam oriented through the at least one window plate 24, which is to be deflected with the aid of the optical element onto a setpoint incidence surface, may therefore be reliably prevented from being incident on the setpoint incidence surface of the light beam. In particular in the case of a use of the window-equipped cover for a micro-mirror device for image generation, light spots, which are frequently perceived to be annoying, and which conventionally often occur during the passage of an optical beam through a conventional transparent window, may thus be suppressed in the generated image.

If multiple window plates 24 are introduced into multiple openings 10, window plates 24 may optionally be oriented in different inclinations in relation to front side 12 and/or rear side 20. For example, two adjacent window plates 24 may be situated rotated by 180° to one another on substrate 14/wafer. The angles of inclination of window plates 24 may also be varied; in particular, they may be established nonspecifically. The orientation of multiple window plates 24 at the same angle of inclination in relation to front side 12 and/or rear side 20 as shown in FIG. 1b is only to be understood as an example.

In addition, in the case of the manufacturing method described here, at least one gap 30 between at least one outer edge 24a of the at least one window plate 24 and particular opening 10 is at least partially filled and/or covered with the aid of at least one sealant and/or adhesive 32 from a side of the at least one window plate 24 oriented toward front side 12 of substrate 14 (see FIG. 1c). Outer edge 24a of the at least one window plate 24 may be understood as a boundary area of the at least one window plate 24 which lies between the two window surfaces/maximum outer surfaces of the at least one window plate 24. The at least one sealant and/or adhesive 32 is preferably applied directly to at least one edge of outer edge 24a, which contacts substrate 14, from the side of the at least one window plate 24 oriented toward front side 12 of substrate 14. Due to the tilting of the at least one window plate 24, it is generally automatically ensured that at least one edge of outer edge 24a abuts substrate 14, in particular at outer walls 17 and 19. In particular, an excess of the at least one sealant and/or adhesive 32 may occur on the side of the at least one window plate 24 oriented toward front side 12 of substrate 14, while the abutting of outer edge 24a on substrate 14 prevents the at least one sealant and/or adhesive 32 from seeping through to the side of the at least one window plate 24 oriented toward rear side 20 of substrate 14.

For example, a soldering material, in particular a hermetically sealing soldering material, for example, sealing glass, may be used as the at least one sealant and/or adhesive 32. The soldering material may be melted onto the edge regions of window plate 24 by heating, in particular after an application, so that the soldering material runs into the at least one gap 30. After cooling of the soldering material, a fastening for the at least one window plate 24 results in this way, which ensures its reliable hold in the at least one opening 10 while maintaining the desired inclined orientation.

The at least one entire outer edge 24a of the at least one window plate 24 is preferably covered by the at least one sealant and/or adhesive 32 in such a way that at least one seal is created, which frames a window middle surface 34 of particular window plate 24 which is oriented toward front side 12 of substrate 14. In particular, the at least one gap 30 between the at least one window plate 24 and the at least one opening 10 may be filled and/or covered in a liquid-tight and/or airtight manner with the aid of the at least one seal made of the at least one sealant and/or adhesive 32.

The introduction of the at least one sealant and/or adhesive 32 into the at least one gap 30 may be carried out after the at least one window plate 24 is situated therein. As an alternative thereto, the at least one window plate 24 may already be at least partially coated using the at least one sealant and/or adhesive 32 before it is situated in the at least one opening 10. For example, a wafer made of a light-transmissive material may be at least partially covered/printed using the at least one sealant and/or adhesive 32. Subsequently, window plates 24 may be structured/sawn out of the wafer, the partition lines being able to be established in such a way that at least one sealant and/or adhesive 32 is provided on the outer areas of isolated glass plates 24.

Optionally (after the introduction of the at least one window plate 24 and/or the at least partial filling/partial covering of the at least one gap 30 using the at least one sealant and/or adhesive 32) at least one base area of 36 of the at least one opening 10, which is located between first partial area 26 of first base partial surface 16 and second partial area 28 of second base partial surface 18, may be removed with the aid of etching starting from rear side 20 of substrate 14. In this way, a light beam may be directed later through the at least one opening 10. A DRIE etching step and/or a KOH etching step may also be used for carrying out the rear side etching. The at least one base area 36 to be removed during the rear side etching may be reliably established with the aid of an optional photolithography step.

In one advantageous refinement of the above-explained manufacturing method, inclined outer walls 17 and 19 (cavity flanks) may be implemented in the at least one opening 10, for example, with the aid of KOH etching. Subsequently, in each case one trapezoidal window plate 24 may be inlaid in a quasi-self-aligning manner into the at least one opening 10.

If the above-described method steps are carried out at the wafer level, subsequently, a plurality of window-equipped covers 38 may be structured out of the wafer used as substrate 14 with the aid of isolation/sawing. However, it is to be noted once again that the above-described method steps are also capable of manufacturing only one single window-equipped cover 38.

In one method step (not shown), finished manufactured window-equipped cover 38 may be fastened on at least one subunit of an optical device. For example, a bonding method may be carried out for this purpose. In this way, in particular a desired partial vacuum or overpressure may also be ensured in an inner chamber sealed with the aid of window-equipped cover 38.

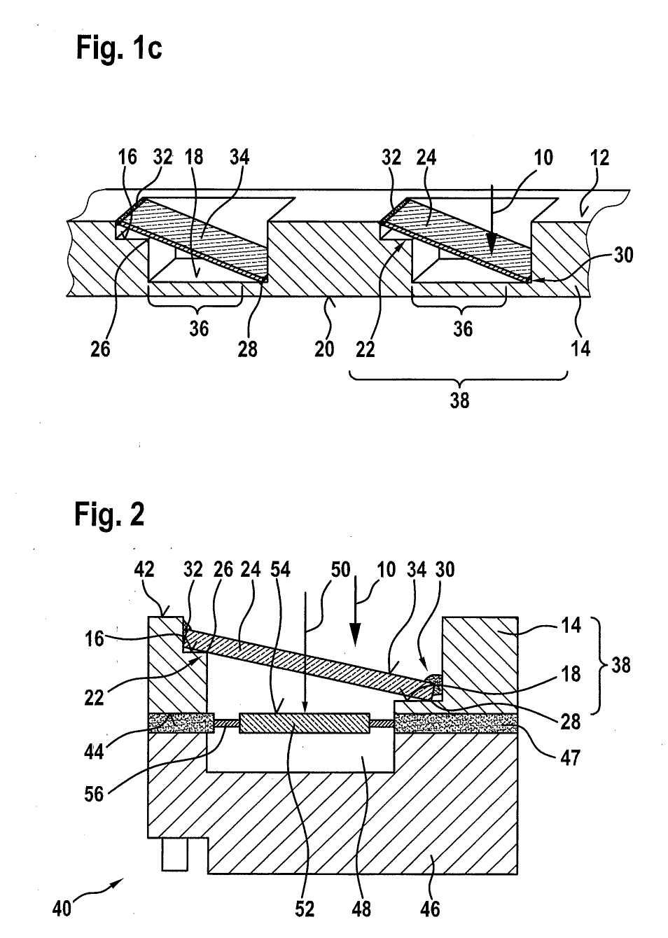

FIG. 2 shows a schematic view of one specific embodiment of the window-equipped cover.

Window-equipped cover 38 which is schematically shown in FIG. 2 is fastened on an optical device implemented as a micro-mirror device 40. However, it is to be noted that the implementation of the optical device as a micromechanical component, in particular as a micro-mirror device 40, which is schematically shown in FIG. 2, is only to be interpreted as an example. Window-equipped cover 38 may be used for capping a variety of different optical devices.

Window-equipped cover 38 has a (residual) substrate 14 having at least one through opening 10. The at least one through opening 10 has an expansion to a first surface 42 of substrate 14 in such a way that in each case one base partial surface 16 of the at least one opening 10 is implemented at a first depth t1 in relation to first surface 42 of substrate 14 and one second base partial surface 18 of the at least one opening 10 is implemented at a greater second depth t2 in relation to first surface 42 of substrate 14. At least one window plate 24, which is situated in the at least one opening 10, contacts at least one first partial area 26 of first base partial surface 16 and at least one second partial area 28 of second base partial surface 18 of particular opening 10 (as support surfaces).

In addition, at least one gap 30 between at least one outer edge 24a of the at least one window plate 24 and particular opening 10 is at least partially filled and/or covered using at least one sealant and/or adhesive 32 from a side, which is oriented toward first surface 42 of (residual) substrate 14, of the at least one window plate 24. The at least one sealant and/or adhesive 32 is preferably applied from the side of the at least one window plate 24 oriented toward first surface 42 directly onto at least one edge of outer edge 24a which contacts (residual) substrate 14. In particular, an excess of the at least one sealant and/or adhesive 32 may be present on the side of the at least one window plate 24 oriented toward first surface 42. In contrast, the butt joints of outer edge 24a on substrate 14 on the side of the at least one window plate 24 oriented toward second surface 44 of substrate 14 may be free of the at least one sealant and/or adhesive 32.

Window-equipped cover 38 ensures the above-described advantages. In addition, window-equipped cover 38 is manufacturable in a simple way and cost-effectively with the aid of the above-described manufacturing method.

The manufacture of window-equipped cover 38 with the aid of the manufacturing method according to the present invention is generally also recognizable in that an orientation of base partial surfaces 16 and 18 deviates from the angle of inclination of window plate 24 introduced into particular opening 10. In particular, adjacent window plate 24 may be oriented inclined in relation to base partial surfaces 16 and 18. For example, window plate 24 only contacts second base partial surface 18 at one edge. A contact between window plate 24 and first base partial surface 16 may also only be present on one boundary area, one tip, or one edge of first base partial surface 16. This may also be described by saying that window plate 24 is supported by base partial surfaces 16 and 18 in an inclined orientation to base partial surfaces 16 and 18.

It is to be noted that first base partial surface 16 of the at least one opening 10 at first depth t1 and/or second base partial surface 18 of the at least one opening 10 at second depth t2 may be implemented in parallel to first surface 42 of substrate 14. The structuring of the at least one opening 10 into substrate 14 may therefore be easily carried out.

In the specific embodiment of FIG. 2, window-equipped cover 38 is fastened at second surface 44, which is directed away from first surface 42, on a mount 46 of micro-mirror device 40, or another optical device. In particular, window-equipped cover 38 may be fastened with the aid of an adhesive connection or bonded connection 47 on micro-mirror device 40/optical device. First surface 42 may optionally also be used for attaching window-equipped cover 38 to at least one subunit of micro-mirror device 40/optical device. (The two surfaces 42 and 44 may be differentiated with the aid of the expansion of the at least one opening 10).

A seal may be formed from the at least one sealant and/or adhesive 32, which covers the at least one entire outer edge 24a of the at least one window plate 24 and frames a window middle area 34 of particular window plate 24 oriented toward first surface 42 of substrate 14. The at least one gap 30 between the at least one outer edge 24a of the at least one window plate 24 and the at least one opening 10 may preferably be filled and/or covered in a liquid-tight and/or airtight manner with the aid of the at least one seal. With the aid of a liquid-tight seal, an inner chamber 48 of micro-mirror device 40/optical device, which is capped by window-equipped cover 38, may be protected from a penetration of liquids. In particular, a desired partial vacuum or overpressure may be set in inner chamber 48 by an airtight seal.

Window-equipped cover 38 may also be used as a light-optical access for a light beam 50 incident in inner chamber 48 and/or as a light-optical outlet for a light beam (not shown) exiting from inner chamber 48. At least one optical element 52, for example, a mirror and/or a filter, is preferably situated in inner chamber 48. Window-equipped cover 38 ensures a good protection of optical element 52 and further components situated in inner chamber 48 from atmospheric influences. Window-equipped cover 38 may therefore lengthen a service life of micro-mirror device 40/optical device and improve its functionality. Due to the inclined orientation of the at least one window plate 24 in relation to at least one surface 42 and 44 of substrate 14, window-equipped cover 38 is fastenable easily on mount 46, an inclined orientation of the at least one window plate 24 in relation to an outer surface 54 of optical element 52 facing toward it, for example, a reflective surface of a mirror, being able to be ensured simultaneously. The incidence of light reflected on the at least one window plate 24 on an image surface of optical element 52/facing outer surface 54 may therefore be prevented.

The at least one optical element 52 may in particular be situated with the aid of at least one spring 56 so it is adjustable in inner chamber 48 in relation to mount 46. An actuator (not shown) may be used for adjusting the at least one optical element 52, a variety of different actuator types being implementable for the actuator. In particular, a good adjustability of optical element 52 may be ensured by the easy implementability of a partial vacuum in inner chamber 48. Micro-mirror device 40 equipped with the window-equipped cover may therefore advantageously be used as a light projector, without interfering reflections occurring on an image projected thereby.

What is claimed is:

1. A window-equipped cover for an optical device, comprising:
a substrate provided with at least one through opening having an expansion toward a first surface of the substrate in such a way that (i) one first base partial surface of the at least one opening at a first depth in relation to the first surface of the substrate is provided, and (ii) one second base partial surface of the at least one opening at a greater second depth in relation to the first surface of the substrate is provided; and
at least one window plate situated in the at least one opening and contacting at least one first partial area of the first base partial surface and at least one second partial area of the second base partial surface of the at least one opening;
wherein at least one gap between at least one outer edge of the at least one window plate and the at least one opening is at least one of partially filled and covered, using at least one of a sealant and an adhesive, from a side of the at least one window plate oriented toward the first surface of the substrate.

2. The window-equipped cover as recited in claim 1, wherein at least one of (i) the first base partial surface of the at least one opening at the first depth and (ii) the second base partial surface of the at least one opening at the second depth is provided in parallel to the first surface of the substrate.

3. The window-equipped cover as recited in claim 2, wherein a seal made of the at least one of the sealant and the adhesive (i) entirely covers the at least one outer edge of the at least one window plate and (ii) frames a window middle area of the at least one window plate oriented toward the first surface of the substrate.

4. The window-equipped cover as recited in claim 3, wherein the at least one gap between the at least one outer edge of the at least one window plate and the at least one opening is at least one of filled and covered in at least one of a liquid-tight and airtight manner with the aid of the at least one seal.

5. The window-equipped cover as recited in claim 4, wherein the window-equipped cover is part of an optical device.

6. A manufacturing method for manufacturing a window-equipped cover for an optical device, comprising:
producing at least one opening in a front side of a substrate, the at least one opening having (i) at least one first base partial surface of the at least one opening at a first depth in relation to the front side of the substrate and (ii) one second base partial surface of the at least one opening at a greater second depth in relation to the front side of the substrate;
introducing at least one window plate into the at least one opening in such a way that the at least one window plate is supported on at least one first partial area of the first base partial surface and on at least one second partial area of the second base partial surface of the at least one opening; and
at least one of partially filling and covering at least one gap between at least one outer edge of the at least one window plate and the at least one opening, with the aid of at least one of a sealant and an adhesive, from a side of the at least one window plate oriented toward the front side of the substrate.

7. The manufacturing method as recited in claim 6, wherein, during the production of the at least one opening, at least one of (i) the first base partial surface of the at least one opening at the first depth and (ii) the second base partial surface of the at least one opening at the second depth is implemented in parallel to the front side of the substrate.

8. The manufacturing method as recited in claim 7, wherein the at least one outer edge of the at least one window plate is entirely covered by the at least one of the sealant and the adhesive in such a way that at least one seal is formed, and wherein the at least one seal frames a window middle area of the at least one window plate oriented toward the front side of the substrate.

9. The manufacturing method as recited in claim 8, wherein the at least one gap between the at least one window plate and the at least one opening is at least one of filled and covered in at least one of a liquid-tight and airtight manner with the aid of the at least one seal.

10. The manufacturing method as recited in claim 8, wherein during the production of the at least one opening, the at least one first base partial surface is implemented as a surface of a step, and the at least one window plate is supported on an edge of the step as the first partial area of the first base partial surface.

11. The manufacturing method as recited in claim 10, wherein the at least one opening is implemented partially through the substrate before the introduction of the at least one window plate.

12. The manufacturing method as recited in claim 10, wherein, after the introduction of the at least one window plate, at least one base area of the at least one opening is removed with the aid of etching starting from a rear side of the substrate, and wherein the at least one base area lies between the first partial area of the first base partial surface and the second partial area of the second base partial surface.

13. The manufacturing method as recited in claim 10, wherein the manufacturing method is carried out at the wafer level.

14. The manufacturing method as recited in claim 8, further comprising:
fastening the window-equipped cover on at least one subunit of the optical device.

15. The manufacturing method as recited in claim 10, further comprising:
fastening the window-equipped cover on at least one subunit of the optical device.
